(19) United States
(12) Patent Application Publication
(10) Pub. No.: US 2024/0416772 A1
(43) Pub. Date: Dec. 19, 2024

(54) ELECTRIC VEHICLE CHARGING SYSTEM WITH CHARGING CABLE ANTI-THEFT SYSTEM

(71) Applicant: EVJAM LLC, Minneapolis, MN (US)

(72) Inventors: Steven DICKE, Minneapolis, MN (US); Gregg KROMREY, Hudson, WI (US)

(73) Assignee: EVJAM LLC, Minneapolis, MN (US)

(21) Appl. No.: 18/815,800

(22) Filed: Aug. 26, 2024

Related U.S. Application Data
(63) Continuation-in-part of application No. 18/668,516, filed on May 20, 2024.
(60) Provisional application No. 63/467,909, filed on May 19, 2023.
(60) Provisional application No. 63/534,393, filed on Aug. 24, 2023.

(51) Int. Cl. B60L 53/30; B60L 53/18

(52) U.S. Cl. CPC B60L 53/30; B60L 53/18; B60L 2270/34

(57) ABSTRACT

One or more examples provide an electric vehicle or a device for use with an electric vehicle, including an electric vehicle charging system and method with charging cable anti-theft system.

### CROSS REFERENCE TO RELATED APPLICATIONS

This Non-Provisional patent application is a continuation-in-part of U.S. patent application Ser. No. 18/668,516, filed May 20, 2024, which claims the benefit of the filing date of U.S. Provisional Patent Application Ser. No. 63/467,909, filed May 19, 2023; and claims the benefit of the filing date of U.S. Patent Provisional Application Ser. No. 63/534,393, filed Aug. 24, 2023, all of which are herein incorporated by reference.

### TECHNICAL FIELD

The present disclosure relates generally to examples of electric vehicles and to devices for use with an electric vehicle, including electric vehicle charging systems and devices.

### BACKGROUND

Electric vehicles and electric vehicle devices provide quiet, clean, and efficient powertrains for moving from place to place or for getting work done. Electric vehicle charging stations and charging cables are targeted by thieves due to the value of the charging station and charging vehicle components.

For these and other reasons, there is a need for the present invention.

### SUMMARY

The present disclosure provides one or more examples of an electric vehicle and systems and/or devices for use with an electric vehicle. In one or more examples, the system is an electric vehicle charging system and/or charging device, including a charging cable anti-theft system.

Additional and/or alternative features and aspects of examples of the present technology will become apparent from the following description and the accompanying drawings.

### BRIEF DESCRIPTION OF THE DRAWINGS

The Figures generally illustrate one or more examples of an electric vehicle and/or devices for use with an electric vehicle such as electric vehicle batteries or electric vehicle charging systems and devices, including an electric vehicle charging system with a hidden charging interface.

FIG. 1 is a diagram generally illustrating a charging system, according to examples of the present disclosure.

FIG. 2 is a diagram illustrating a charging system, according to examples of the present disclosure.

FIG. 3 is a diagram illustrating a hidden charging unit, according to examples of the present disclosure.

FIG. 4 is a diagram illustrating a hidden charging unit including a landscape element, according to examples of the present disclosure.

FIG. 5 is a diagram illustrating a hidden charging unit including a landscape element, according to examples of the present disclosure.

FIG. 6 is a diagram illustrating a hidden charging unit including a landscape element, according to examples of the present disclosure.

FIG. 7 is a diagram illustrating a hidden charging unit including a landscape element, according to examples of the present disclosure.

FIG. 8 is a diagram illustrating a hidden charging unit including a landscape element, according to examples of the present disclosure.

FIG. 9 is a diagram illustrating a hidden charging unit including a landscape element, according to examples of the present disclosure.

FIG. 10 is a diagram illustrating a hidden charging unit including a landscape element, according to examples of the present disclosure.

FIG. 11 is a diagram illustrating a hidden charging unit including a landscape element, according to examples of the present disclosure.

FIG. 12 is a diagram illustrating a hidden charging unit including a landscape element, according to examples of the present disclosure.

FIG. 13A is a diagram illustrating a charging cable for use with the charging system, according to examples of the present disclosure.

FIG. 13B is a diagram illustrating a charging cable including one or more alarm components for use with the charging system, according to examples of the present disclosure.

FIG. 14A is a diagram illustrating a charging system including a hidden charging unit and charging cable, according to examples of the present disclosure.

FIG. 14B is a diagram illustrating a charging system including a hidden charging unit and charging cable, according to examples of the present disclosure.

FIG. 15 is a diagram illustrating an electric vehicle charging cable having a theft deterrent system, according to examples of the present disclosure.

FIG. 16 is a diagram illustrating one example of a charging cable with theft deterrent system.

FIG. 17 and FIG. 18 are diagrams illustrating a charging cable having a theft deterrent system for use with a charging system, according to examples of the present disclosure.

FIG. 19 illustrates one example of a charging cable including a theft deterrent compound.

FIG. 20 illustrates one example of a theft deterrent tape.

FIG. 21 illustrates one example of a charging cable having a theft deterrent compound.

FIG. 22 illustrates one example of a spray device.

FIG. 23 illustrates one example of spray device when in an alarm condition.

FIG. 24 illustrates one example charging cable having a theft deterrent system.

FIG. 25 is a diagram illustrating one example operation of a charging cable having a proximity sensor.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense. It is to be understood that features of the various examples described herein may be combined, in part or whole, with each other, unless specifically noted otherwise.

Electric vehicles (EVs), such as automobiles (e.g., cars and trucks), autonomous vehicles, watercraft, all-terrain vehicles (ATVs), side-by-side vehicles (SSVs), and electric bikes, for example, offer a quiet, clean, and more environmentally friendly option to gas-powered vehicles. Electric vehicles have electric powertrains which typically include a battery system, one or more electrical motors, each with a corresponding electronic power inverter (sometimes referred to as a motor controller), and various auxiliary systems (e.g., cooling systems).

Electric Vehicle Charging System with Hidden Charging Interface

The present disclosure provides an EV charging system with a hidden charging interface. In one application, the charging system is suitable for use in a garage, house, shed or other out unit set-up where the electric vehicle charging station is located a distance from the location of a vehicle needing a charge. The present charging system is suitable for use in large cities where it may be desired to keep one or more components of the charging system out of sight.

In one example, the electric vehicle charging system includes an electrical charging station, a charging interface unit and a charging cable with a charging plug. The electric vehicle charging station can be located in a garage, house, shed or other location. The charging interface unit is electrically coupled to the charging station, and can be located near a parking location for a vehicle needing a charge. A charging cable can be quick coupled to the charging interface unit for charging the electric vehicle. The charging interface unit may or may not be a “smart” unit that is capable of communicating (wired or wirelessly) with the ev charging station or a remote device (e.g., application interface device such as a phone).

In one application, the charging interface unit is hidden and has a housing that takes on the shape or form of an exterior element such as a landscape element. Examples of the charging interface unit housing configuration include a decorative post, faux landscape element (e.g., a rock), retaining wall block, plant/rock container, curb, fence/fence post structure, or a stone paver.

In one application, the charging interface device and charging cable include one or more alarm components. For example, the charging cable can include one or more alarm wires located either in the insulated cable jacket or inside the cable jacket. The alarm control wires can also be in the form of conductive foil or a conductive shield member located either in the cable jacket or inside the cable jacket. In one example, if the charging cable is cut the breaking of alarm wires/foil would trigger an alarm. The alarm can be localized and/or notify a charging station owner via an external system such as an application device. A movement detection device (e.g., an accelerometer) could also be located along the charging cable or as part of the charging plug to notify the user/owner that the charging cable is being moved and/or tampering of the charging cable/charging system.

Operation of the electric vehicle charging system may be done either local to the charging vehicle or remotely via a computer, ev control system, charging station control system, or a user control application located on a smart device (e.g., via a phone).

An Electric Vehicle Charging System with a Hidden Charging Interface can Include a Combination of One or More of the Following Features:

Electric Vehicle Charging System. EV charging system with a hidden charging interface. The charging system is suitable for use in a garage, house, shed or other out unit set-up where the electric vehicle charging station is located a distance from the location of a vehicle needing a charge. The present charging system is suitable for use in large cities where it may be desired to keep one or more components of the charging system out of sight. In one example, the electric vehicle charging system includes an electrical charging station, a charging interface unit and a charging cable with a charging plug.

The electric vehicle charging station can be located in a garage, house, shed or other location. The charging interface unit is electrically coupled to the charging station, and can be located near a parking location for a vehicle needing a charge. A charging cable can be quick coupled to the charging interface unit for charging the electric vehicle. The charging interface unit may or may not be a “smart” unit that is capable of communicating (wired or wirelessly) with the ev charging station or a remote device (e.g., application interface device such as a phone).

Charging Unit with Hidden Charging Interface. In one application, the charging interface unit is hidden and has a housing that takes on the shape or form of an exterior element such as a landscape element. Examples of the charging interface unit housing configuration include a decorative post, faux landscape element (e.g., a rock), retaining wall block, plant/rock container, curb, fence/fence post structure, or a stone paver.

Alarm components. In one application, the charging interface device and charging cable include one or more alarm components. For example, the charging cable can include one or more alarm wires located either in the insulated cable jacket or inside the cable jacket. The alarm control wires can also be in the form of conductive foil or a conductive shield member located either in the cable jacket or inside the cable jacket.

Cable Cut/Break Alarm. In one example, if the charging cable is cut the breaking of alarm wires/foil would trigger an alarm. The alarm can be localized and/or notify a charging station owner via an external system such as an application device.

Movement Detection. A movement detection device (e.g., an accelerometer) could also be located along the charging cable or as part of the charging plug to notify the user/owner that the charging cable is being moved and/or tampering of the charging cable/charging system.

Charging System Operation. Operation of the electric vehicle charging system may be done either local to the charging vehicle or remotely via a computer, ev control system, charging station control system, or a user control application located on a smart device (e.g., via a phone).

Charging Cable. Charging Cable Plugs. The charging cable can be portable and configured for use with a specific charging vehicle. In one example, the charging cable includes a first plug for coupling to the charging interface unit and a second plug for coupling to the charging port of an electric vehicle.

Quick Couple Plug. In one example, the first plug is suitable for quick coupling to the charging interface unit.

Lockable Plug. The quick couple plug may be lockable, and include a locking mechanism for securely locking the plug to the charging interface unit.

Retractable Charging Cord. In one example, a reel mechanism is located in the charging interface unit. The charging cable is capable of being retractable about the reel mechanism when not in use.

Multiple Piece Charging Plug. In one example, the charging plug includes at least two components. The first component is capable of sinking out of sight into the housing of the charging interface unit when not in use. When extended for a charging operation, a second component in the form of a plug adapter specific to the vehicle being charged is coupled to the first component. The plug second component can be mechanically coupled to the plug first component or magnetically coupled to the first component (e.g., electromagnetically).

Charging System with Charging Cable Anti-Theft System. The charging system can include a charging station having a charging cable alarm, and/or a charging cable anti-theft system. In one or more examples, the anti-theft system includes a cable alarm, a theft deterrent, and/or a tracking system.

Charging cable with theft-deterrent. The charging cable can include a theft deterrent. The theft deterrent could be located along the length of the charging cable or in specific locations (e.g., near the ends of the charging cable where more likely to be cut).

In one example, the theft deterrent includes a theft deterrent compound located in the cable. Theft deterrent compounds could be made up of a material causing an odor, foul scented, color marker (e.g., blue paint), etc. The charging cable could have a built-in delay in release of the compound. Will release later, allowing release to occur away from the charging station (e.g., in theft vehicle, etc.). Could be located in a release capsule, or part of a timed release mechanism for later release of the theft deterrent.

Alarm cable could be active. Low voltage applied. Monitor current. Could monitor voltage. If changes, alarm. Alarms can be located at charging station or cable.

In one example, if the charging cable is cut, the cut cable releases a spray compound, like a bear spray. In one example, theft deterrent compounds could be a material that reacts with air.

The cable alarm could be deactivated once cable is actively in use charging a vehicle.

In one example, a tracking/trackable device (e.g., a gps tracking tag or apple air tag) is located in cable or cable insulation.

In one example, a proximity sensor is associated with the cable or plug and charging station. When out of range from each other, the charging station alarm mode is activated and we know something is wrong.

In one example, an accelerometer is located along the length of the cable, including the charging plug. When a predetermined movement level is reached, an alarm is activated. Alarm can be a silent alarm (e.g., software alarm notifying a user via an app), visual alarm (e.g., a bright, flashing light) or a sound alarm, etc.

In another example, a cable theft alarm is located in the charging cable coupler.

### One or More Examples and Features of the Charging System are Detailed Herein and Illustrated in the Figures.

One example provides an electric vehicle charging system. The electric vehicle charging system includes an electric vehicle charging station. A hidden charging unit is spaced from the electric vehicle charging station and electrically coupled to the electric vehicle charging station. A charging cable is coupled to the hidden charging device.

One example provides a faux landscape element. The faux landscape element includes a housing configured as a landscape element. A component cavity is located within the housing. A charging interface unit is located within the housing, including a charge coupling device that extends through the housing.

One example provides an electric vehicle charging system. The electric vehicle charging system includes a hidden charging unit spaced from an electric vehicle charging station and electrically coupled to the electric vehicle charging station, the hidden charging unit including a housing configured as a landscape element and a charging interface unit integrated into the hidden charging unit.

The charging interface unit comprises a charge coupling device extending through the housing and is configured to couple to an electric vehicle charging cable, and the charging interface unit being coupled to a charging distribution feed. In one example, the hidden charging unit further comprises one or more faux plants.

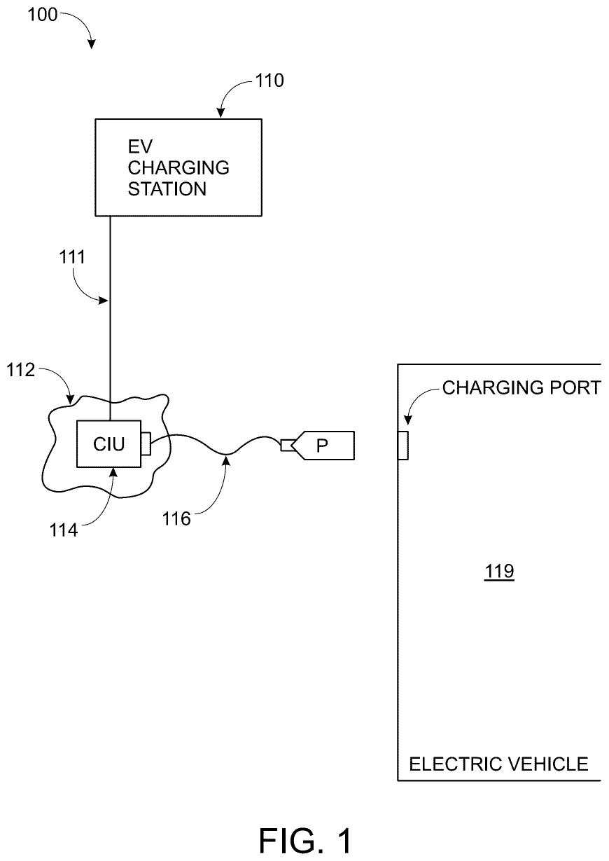

FIG. 1 is a diagram generally illustrating a charging system 100, according to examples of the present disclosure. The charging system 100 includes an electric vehicle charging station 110 and a hidden charging unit 112. The hidden charging unit 112 is spaced from the electric vehicle charging station 110 and electrically coupled to the electric vehicle charging station 110 via distribution charging feed 111. The hidden charging unit 112 includes a charging interface unit 114 integrated into the hidden charging unit 112.

In one example, the charging system includes a charging cable 116. During an electric vehicle charging operation, the charging cable 116 is coupled to the hidden charging device

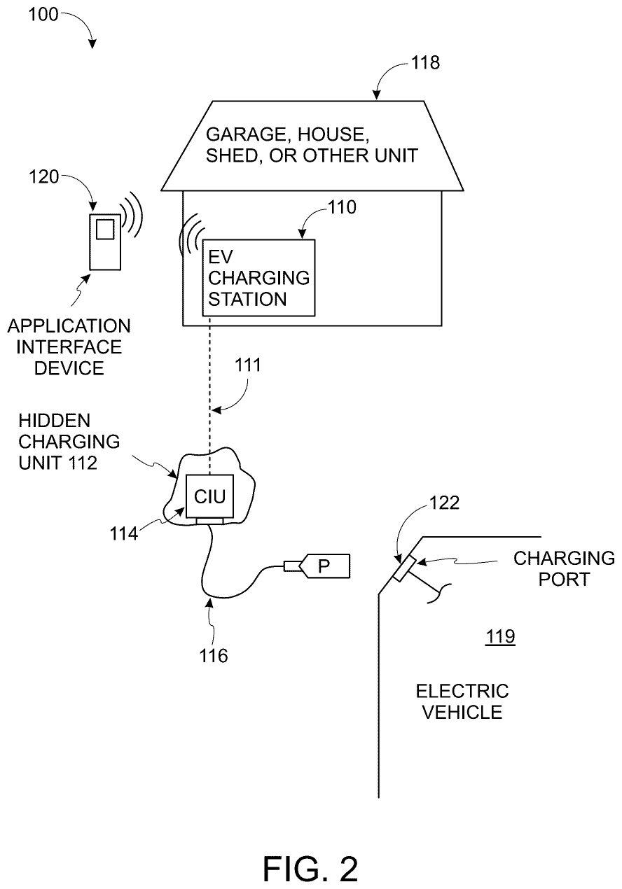

FIG. 2 is a diagram illustrating charging system 100, according to examples of the present disclosure. In this example, the charging system 100 includes electric vehicle charging station 110 located in a garage, shed, or other unit 118. Hidden charging unit 112 is located near the parking location of an electric vehicle 119 requesting a charge. The hidden charging unit 112 includes a charging interface unit 114. In this example, the hidden charging unit 112 is electrically coupled to the electric vehicle charging station 110 via underground distribution charging feed 111. The hidden charging unit 112 is coupled to charging port 122 of the electric vehicle 119 with charging cable 116. The hidden charging unit 112 can communicate directly with ev charging station 110. Desired charging protocol can be controlled via user interface 120.

Charging unit 116 is a hidden charging unit 116. The hidden charging unit 116 is suitable for an urban charging location where it is desired to charge an electric vehicle at home that isn't able to be parked in a garage. Hidden charging unit 116 is kept out of plain sight from possible thieves.

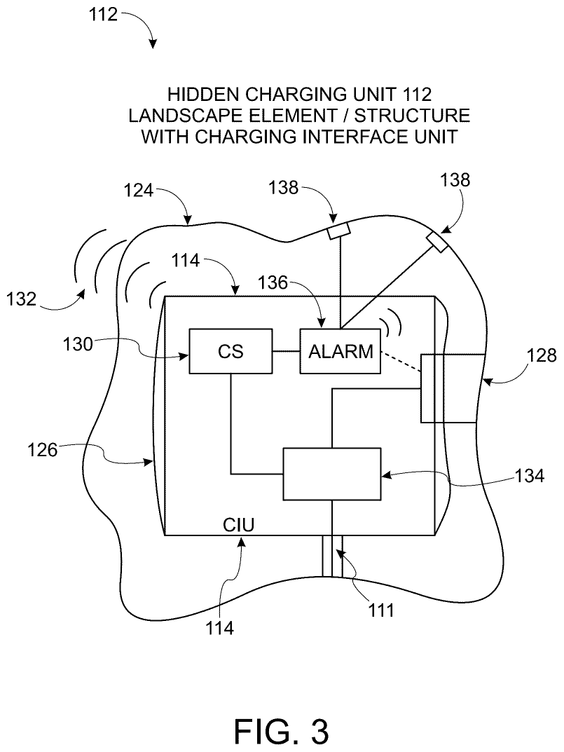

FIG. 3 is a diagram illustrating hidden charging unit 112, according to examples of the present disclosure. The hidden charging unit 114 can be, for example, a landscape element, a landscape structure, or other device. The hidden charging unit 112 includes charging interface unit 114 integrated into the hidden charging unit 112.

In one example, the hidden charging unit 112 includes a housing 124 configured as a landscape element. A component cavity 126 is located within the housing 124. The charging interface unit 114 is located within the component cavity 126. The charging interface unit 114 includes a charge coupling device 128. The charge coupling device 128 extends through housing 124 and aids in coupling the charging interface unit 114 to an electric vehicle, such as electric vehicle 119.

In one example, the charge coupling device 128 is a charging outlet, and includes an outlet box with an electric vehicle charging port connector. In this manner, the charging outlet is similar to an electric vehicle charging port. A charging cable that couples the hidden charging unit 112 would include a charging plug to connect to the charge coupling device 128 charging outlet. In another example, the charge coupling device 128 is a quick couple device that allows for quick coupling and quick disconnect of an electrical connection between the charging interface unit 114 and an ev charging cable.

In one example, the charging interface unit 114 is a smart device, and includes a control system 130. The control system 130 monitors charging parameters of the charging interface unit 114 and is in communication with other charging systems, indicated at 132. The other charging systems include an ev charging station such as ev charging station 110 or an application interface such as application interface device 120. Charging interface unit 114 can include other charging components, including coupling system 134. Coupling system 134 is a power wiring interface that couples incoming power distribution charging feed 111 to charge coupling device 128. Parameters of coupling system 134 are monitored by control system 130.

In one example, charging interface unit 114 includes an alarm system 136. The alarm system 136 can include audio, visual, or digital alarm system components. The alarm system 136 communicates with control system 130 to aid in monitoring and reporting the status of one or more alarm components located in the charging system.

In one example, the alarm system 136 is coupled to alarm sensing and detection components 138 in the hidden charging unit 112 and/or a charging cable (e.g., charging cable 116) coupled to the hidden charging unit 112. Example alarm sensing and detection components include visual or digital alarm status indicators located on the hidden charging unit, and/or cable status alarms. Digital alarms can be communicated to the ev charging station 110 and/or the user interface 120 via control system 130. One or more examples of charging cable status alarms (e.g., cable integrity alarms, cut cable alarm, etc.) are detailed later in this specification.

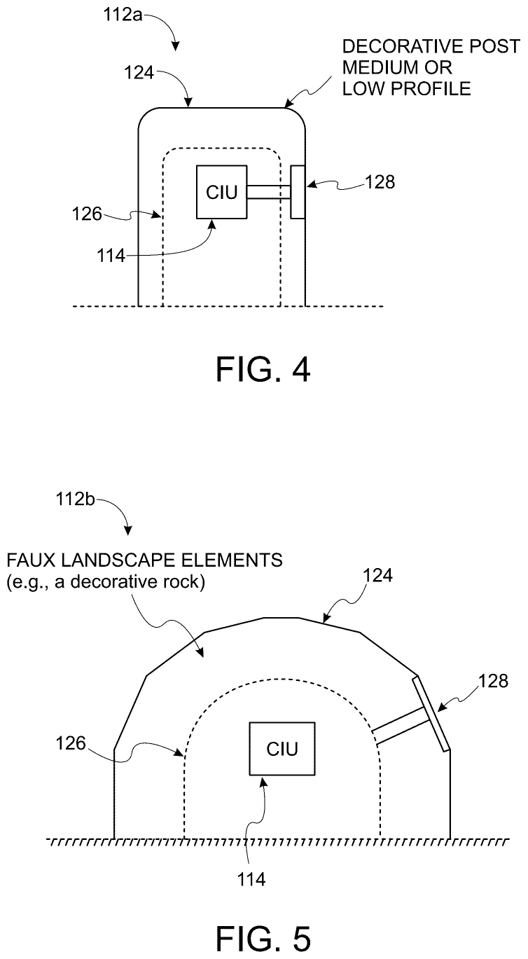

FIG. 4 is a diagram illustrating a hidden charging unit 112a including a landscape element, according to examples of the present disclosure. Hidden charging unit 112a is one example of hidden charging unit 112 previously detailed herein. Hidden changing unit 112a is in the form of a decorative post (e.g., a medium or low profile decorative post). The hidden charging unit 112a includes housing 124 configured as a landscape element. In this example, the housing 124 has an exterior shape of a faux decorative post.

The hidden charging unit 112a further includes an internal component cavity 126. Charging interface unit 114 is located in component cavity 126. Charging interface unit 114 includes charge coupling device 128 that extends through housing 124 such that it is accessible from a location external to the hidden charging unit. Housing 124 includes curved exterior portions and flat exterior portions. In one example, the charge coupling device is located at a flat exterior portion. An additional cable entry for charging feed 111 can be located at the bottom of side of housing 124 for cable access to component cavity 126.

FIG. 5 is a diagram illustrating a hidden charging unit 112b including a landscape element, according to examples of the present disclosure. Hidden charging unit 112b is one example of hidden charging unit 112 previously detailed herein. Hidden changing unit 112b is in the form of a faux landscape element such as a decorative rock. The hidden charging unit 112b includes housing 124 configured as the landscape element, including an exterior surface configured as a rock. In this example, the housing 124 has an exterior shape of a large faux decorative rock.

The hidden charging unit 112b further includes an internal component cavity 126. Charging interface unit 114 is located in component cavity 126. Charging interface unit 114 includes charge coupling device 128 that extends through housing 124 such that it is accessible from a location external to the hidden charging unit. Housing 124 includes curved exterior portions and flat exterior portions. In one example, the charge coupling device 128 is located at a flat exterior portion. An additional cable entry for charging feed 111 can be located at the bottom or side of housing 124 for cable access to component cavity 126.

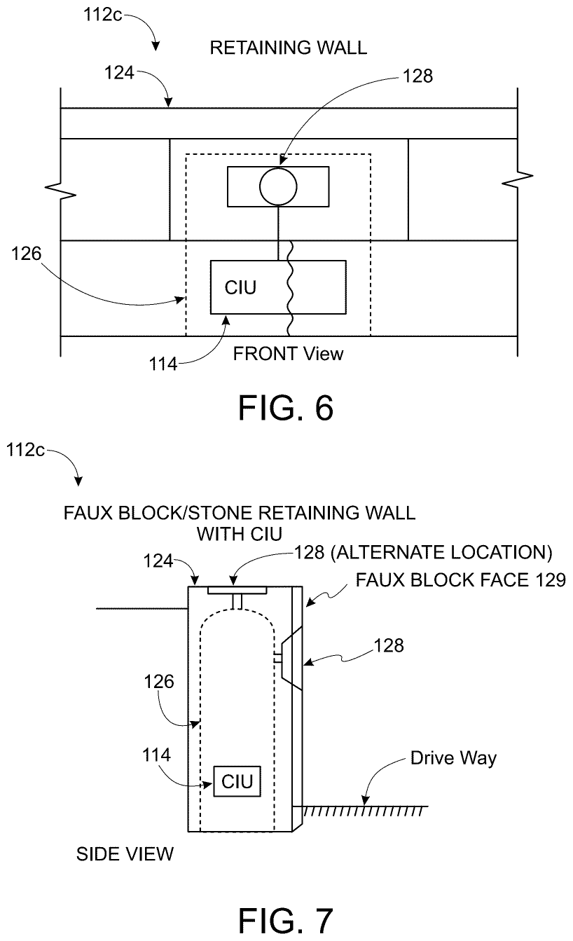

FIG. 6 is a diagram illustrating a hidden charging unit 112c including a landscape element in front view, according to examples of the present disclosure. FIG. 7 is a diagram illustrating the hidden charging unit 112c including a landscape element in side view, according to examples of the present disclosure. Hidden charging unit 112c is one example of hidden charging unit 112 previously detailed herein. Hidden changing unit 112c is in the form of a landscape element such as a retaining wall. The hidden charging unit 112c includes housing 124 configured as the landscape element, including an exterior surface configured as a retaining wall (e.g., the block face illustrated). In this example, the housing 124 has an exterior shape of a retaining wall.

The hidden charging unit 112c further includes an internal component cavity 126. Charging interface unit 114 is located in component cavity 126. Charging interface unit 114 includes charge coupling device 128 that extends through housing 124 such that it is accessible from a location external to the hidden charging unit. Housing 124 includes curved exterior portions and flat exterior portions. In one example, the charge coupling device 128 is located at a flat exterior portion, and extends through faux block face 129. An alternate location for charge coupling device 128 is also illustrated. An additional cable entry for charging feed 111 can be located at the bottom or side of housing 124 for cable access to component cavity 126.

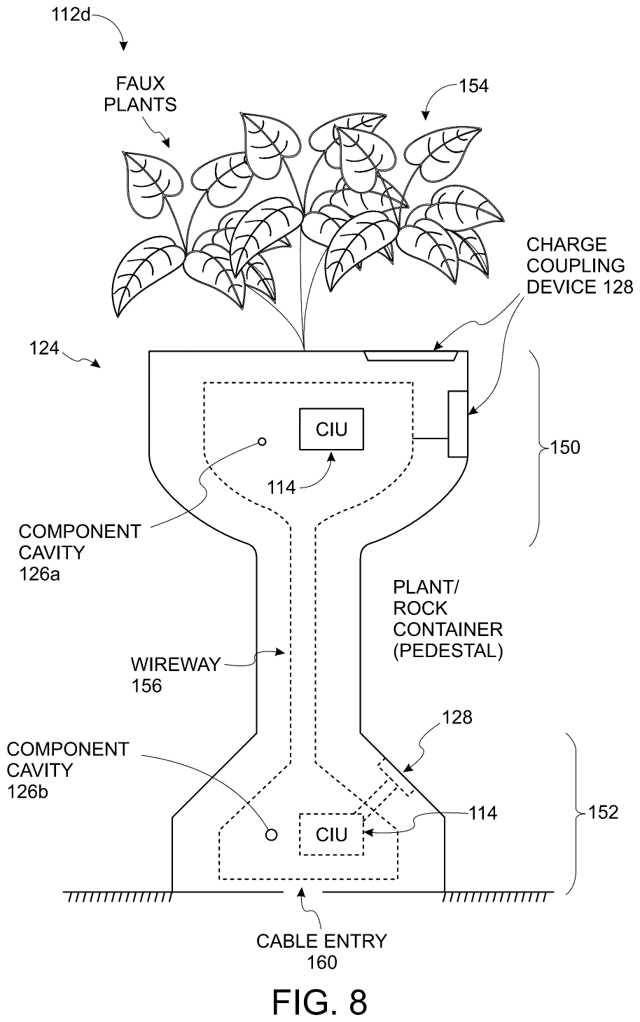

FIG. 8 is a diagram illustrating a hidden charging unit 112d including a landscape element, according to examples of the present disclosure. Hidden charging unit 112d is one example of hidden charging unit 112 previously detailed herein. Hidden changing unit 112d is in the form of a landscape element such as a plant holder. The hidden charging unit 112d includes housing 124 configured as the landscape element (i.e., plant holder).

In this example, housing 124 is a generally hourglass shaped pedestal housing and includes a planter top portion 150 and a planter bottom portion 152. A faux plant 154 is “planted” in planter top portion 150. The hidden charging unit 112d can include one or more component cavities. In one example illustrated, the hidden charging unit 112d includes a first component cavity 126a in planter top portion 150 and a second component cavity 126b in planter bottom portion 152. A wireway 156 connects the first component cavity 126a to the second component cavity 126b. Alternatively, there is only one component cavity, such as the first component cavity 126a located in top portion 150.

A charging interface unit can be located in the first component cavity 126a or the second component cavity 126b. In one example, charging interface unit 114 is located in component cavity 126a. Charging interface unit 114 includes charge coupling device 128 that extends through housing 124 such that it is accessible from a location external to the hidden charging unit 112d. Housing 124 includes curved exterior portions and flat exterior portions. In one example, the charge coupling device 128 is located at a flat exterior portion, and extends through planter housing 124. Alternate example locations for charge coupling device 128 are also illustrated. A cable entry 160 for charging feed 111 can be located at the bottom of housing 124 for cable access to component cavity 126. Alternatively, a cable entry can be located on a side of housing 124.

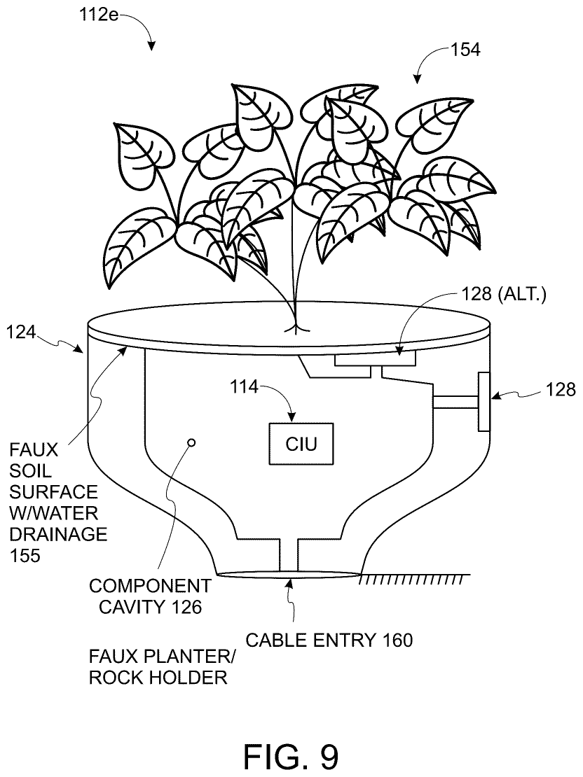

FIG. 9 is a diagram illustrating a hidden charging unit 112e including a landscape element, according to examples of the present disclosure. Hidden charging unit 112e is one example of hidden charging unit 112 previously detailed herein. Hidden changing unit 112e is in the form of a landscape element such as a plant holder. The hidden charging unit 112e includes housing 124 configured as the landscape element (i.e., plant holder), and is similar to the plant holder of FIG. 8 only with a low profile.

In this example, housing 124 is a generally shaped low profile pedestal housing. A faux plant 154 is “planted” in planter, and additionally includes faux soil/dirt 155. The hidden charging unit 112e includes component cavity 126. Charging interface unit 114 is located in component cavity 126. Charging interface unit 114 includes charge coupling device 128 that extends through housing 124 such that it is accessible from a location external to the hidden charging unit 112e. Housing 124 includes curved exterior portions and flat exterior portions. In one example, the charge coupling device 128 is located at a flat exterior portion, and extends through planter housing 124. Alternate example locations for charge coupling device 128 are also illustrated. A cable entry 160 for charging feed 111 can be located at the bottom of housing 124 for cable access to component cavity 126. Alternatively, a cable entry can be located on a side of housing 124.

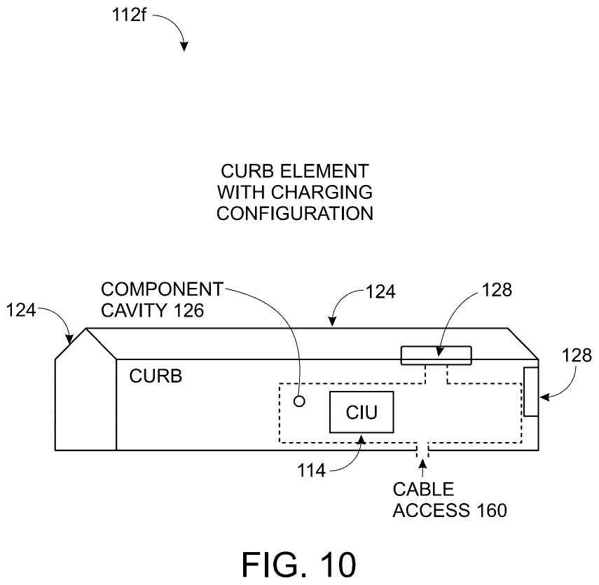

FIG. 10 is a diagram illustrating a hidden charging unit 112f including a landscape element, according to examples of the present disclosure. Hidden charging unit 112f is one example of hidden charging unit 112 previously detailed herein. Hidden changing unit 112f is in the form of a curb element. The hidden charging unit 112f includes housing 124 configured as a landscape element. In this example, the housing 124 has an exterior shape of a vehicle curb stop. The vehicle curb stop can be an actual curb stop or faux curb stop In one example, the curb stop is made of cement. In other examples, the curb stop is a faux curb stop and is made of a faux rock or other synthetic/rubber material.

The hidden charging unit 112f further includes an internal component cavity 126. Charging interface unit 114 is located in component cavity 126. Charging interface unit 114 includes charge coupling device 128 that extends through housing 124 such that it is accessible from a location external to the hidden charging unit. Housing 124 includes curved exterior portions and flat exterior portions. In one example, the charge coupling device is located at a flat exterior portion. An additional cable entry for charging feed 111 can be located at the bottom of side of housing 124 for cable access to component cavity 126.

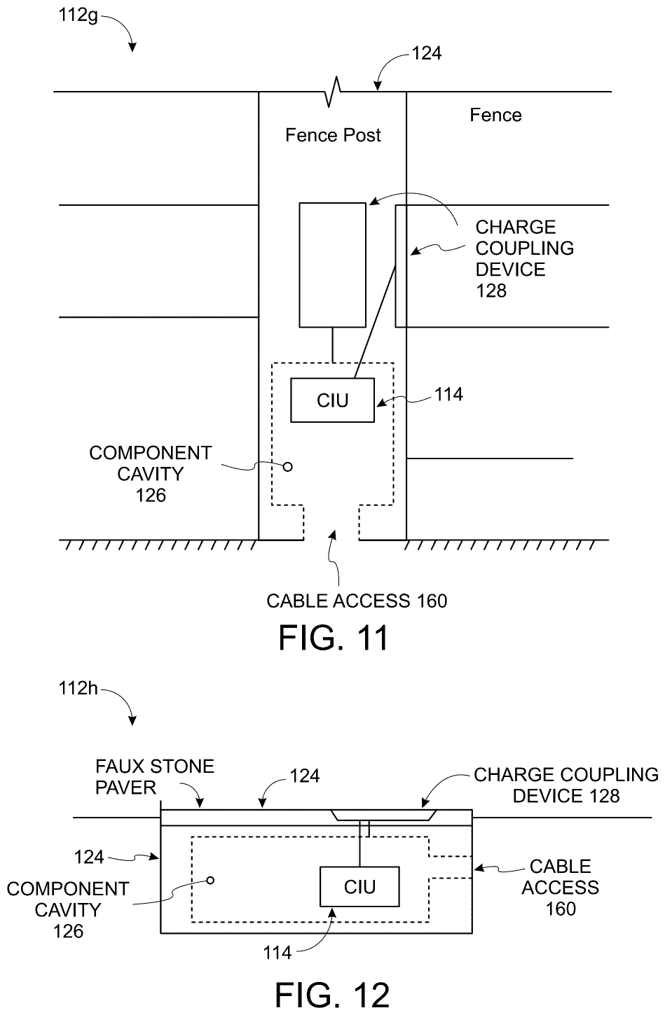

FIG. 11 is a diagram illustrating a hidden charging unit 112g including a landscape element, according to examples of the present disclosure. Hidden charging unit 112g is one example of hidden charging unit 112 previously detailed herein. Hidden changing unit 112g is in the form of a landscape element such as a fence post. The hidden charging unit 112g includes housing 124 configured as the landscape element, including an exterior surface configured as the fence post. In this example, the housing 124 has an exterior shape of a fence post and is part of a fence structure.

The hidden charging unit 112g further includes an internal component cavity 126. Charging interface unit 114 is located in component cavity 126. Charging interface unit 114 includes charge coupling device 128 that extends through housing 124 such that it is accessible from a location external to the hidden charging unit. Housing 124 can include curved exterior portions and flat exterior portions. In one example, the charge coupling device 128 is located at a flat exterior portion of the fence post design, and extends through faux block face 129. An alternate location for charge coupling device 128 is also illustrated where the charge coupling device is located on a side of the fence post that extends outward from the fence. An additional cable entry for charging feed 111 can be located at the bottom or side of housing 124 for distribution feed cable access to component cavity 126.

FIG. 12 is a diagram illustrating a hidden charging unit 112g including a landscape element, according to examples of the present disclosure. Hidden charging unit 112g is one example of hidden charging unit 112 previously detailed herein. Hidden changing unit 112g is in the form of a stone or paver element (e.g., faux stone, patio paver, landscape edge paver, etc.) The hidden charging unit 112g includes housing 124 configured as a landscape element. In this example, the housing 124 has an exterior shape of a stone paver. The stone paver can be an actual stone paver or faux stone paver. In examples, the stone paver can be made of a stone or cement material or a faux stone material such as a hard polymeric material, or just have a veneer faux stone paver surface.

The hidden charging unit 112g further includes an internal component cavity 126. Charging interface unit 114 is located in component cavity 126. Charging interface unit 114 includes charge coupling device 128 that extends through housing 124 such that it is accessible from a location external to the hidden charging unit. Housing 124 includes curved exterior portions and flat exterior portions. In one example, the charge coupling device is located at a flat exterior portion. An additional cable entry for charging feed 111 can be located at the bottom or side of housing 124 for cable access to component cavity 126.

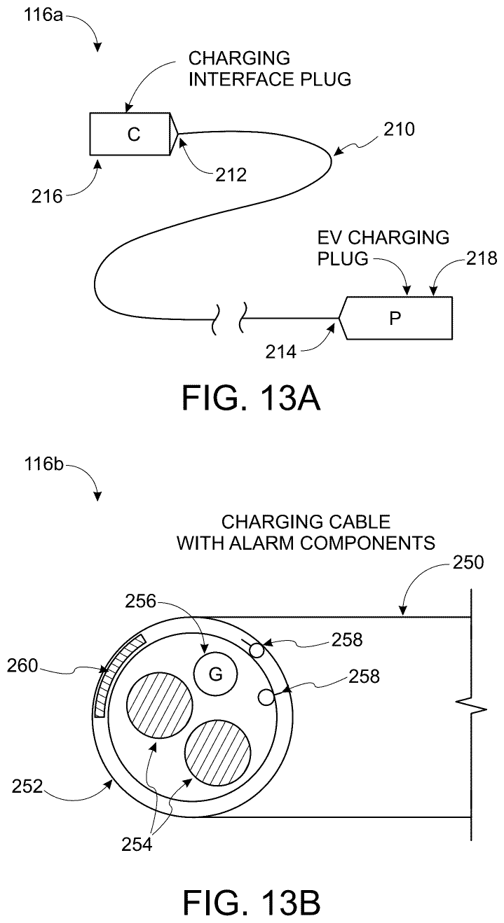

FIG. 13A is a diagram illustrating charging cable 116a for use with the charging system, according to examples of the present disclosure. Charging cable 116a is one example of charging cable 116 previously detailed herein. Charging cable 116a includes a charging plug at each end. Charging cable 116a includes a cable 210 having a first end 212 and a second end 214. A charging plug 216 is located at first end 212, and a charging plug 218 is located at second end 214.

Charging plug 216 plugs into a charge coupling device (e.g. hidden charging unit 112 charge coupling device 128). Charging plug 218 plugs into a charging port of an electric vehicle (e.g., ev 119). In one example, charging plug 216 is a quick coupling device for electrical quick coupling to a hidden charging unit. In another example, the charging plug 216 is configured as an electric vehicle charging plug (e.g., charging plug 218) and the charge coupling device is configured as an electric vehicle charging port.

In one or more examples, the charging plug 216 is a lockable charging plug and can be locked in place to the hidden charging unit, and in one example to the charge coupling device.

FIG. 13B is a diagram illustrating a charging cable 116b for use with the charging system, according to examples of the present disclosure. Charging cable 116b is one example of charging cable 116 previously detailed herein. Charging cable 116b is configured as a cable suitable for charging an electric vehicle and further includes one or more cable alarm components. The cable alarm components are used as part of a cable alarm system to notify a user that the cable needs repair, has been damaged, or cut. The cable alarm components work in connection with the hidden charging unit (e.g., the smart CIU) and/or the vehicle charging station to provide local or remote audio, visual, and/or digital alarm notifications.

In one example, the charging cable 116b is an insulated cable 250 that includes an outer jacket 252 (e.g., an insulated jacket), charging conductors 254 and a ground 256. In one example, alarm/control conductors 258 are located in the outer jacket 252 or inside the insulated jacket 252 with the charging conductors 254. Once connected to a hidden charging unit, a small control current is maintained periodically present in the alarm conductors 258. If damage occurs in the charging cable 116b resulting in the alarm conductors 258 being damaged or cut, the control current in the alarm conductors 258 is cut off or minimized. The charging system (e.g., ev charging station 110 or hidden charging unit 112) senses that the wires have been cut or damaged and goes into an alarm state. Based on a desired alarm protocol, visual or audio alarms can be activated along with digital alarm notifications sent to a user interface (e.g., user interface 120).

In another example, the charging cable 116b includes an alarm or control foil 260 located in the cable outer jacket 252. The foil 260 is capable of carrying a control current, and is operable as part of a cable alarm system similar to the alarm/control conductors 258 previously detailed herein.

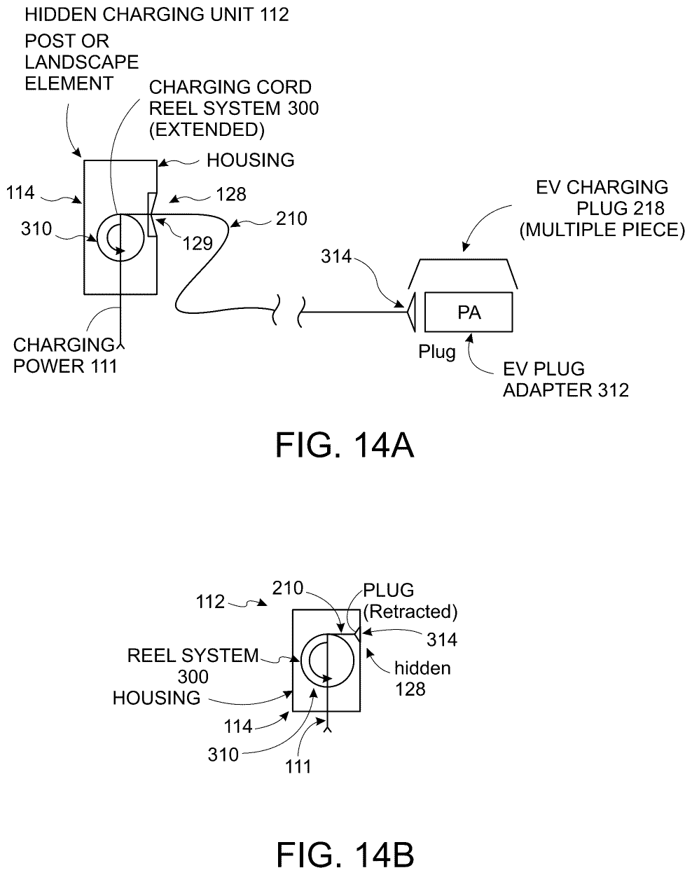

FIG. 14A is a diagram illustrating a charging system including a hidden charging unit and charging cable, according to examples of the present disclosure. In this example, hidden charging unit 112 includes a charge coupling device 128 that is a reel system 300. A charging cable reel 310 is located in the charging interface unit 114. When a user charges their electric vehicle, the plug 218 is simply pulled from the charge coupling device 128 and extended from the cable reel 310 until plug 218 can be plugged into an electric vehicle.

When charging is complete, the charging plug 218 is removed from the electric vehicle charging port and returned to the cable reel 310. FIG. 14B illustrates the cable reel 310 in a retracted, cable storage position. Once in a retracted, cable storage position, the charging cable is hidden within the hidden charging unit and away from the view of an outside observer. In a cable storage position, the cable reel system 300 can be locked in place until needed for future use.

In one example, the ev charging plug 218 is released by the electric vehicle charging port upon completion of a charging operation. The cable reel 310 is a self-retracting reel (e.g., a spring loaded or tensioned reel), and automatically spools the charging cable on the cable reel 310.

In one example, the charging plug 218 is a two piece charging plug and includes a plug adapter 312 and low profile plug 314. During a charging operation, the plug adapter 312 is plugged into a charging port of an electric vehicle, and the low profile plug 314 is magnetically or mechanically coupled to the plug adapter 312. When charging is complete, the charging plug 218 is released. The plug adapter 312 releases the low profile plug from the charging plug 218, and the charging cable is automatically returned to the hidden charging unit 112, including the charging cable 210 being retracted onto cable reel 310. In one example, the charge coupling device includes a plug notch 129. The plug notch 129 has a size and shape that conforms and corresponds to low profile plug 314. When the charging cable is returned to the hidden charging unit 112, the low profile plug 314 fits inside the plug notch out of sight.

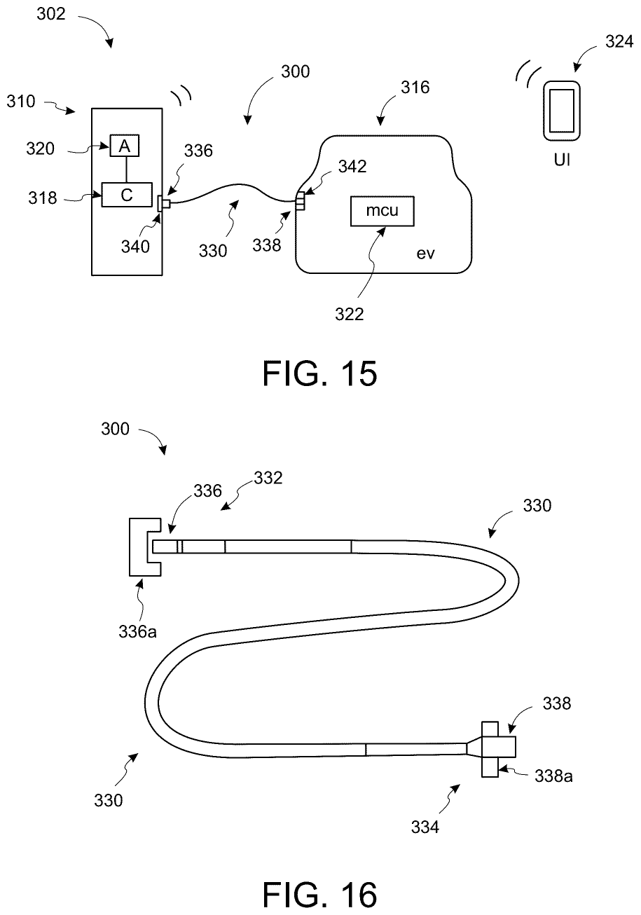

FIG. 15 is a diagram illustrating an electric vehicle charging cable having a theft deterrent system generally at 300, according to examples of the present disclosure. The charging cable 300 can be similar to charging cables previously described herein. The charging cable 300 is suitable for use in an electric vehicle charging system 302. The charging system 302 can be similar to charging systems previously described herein.

The theft deterrent system 300 operates to notify an owner (e.g., ev owner, charging station owner) of an issue with the charging cable. Charging cable issues include cable theft, cable cutting, cable damage, degradation of cable integrity, or other cable issues. Additionally, the theft deterrent system 300 operates to deter theft and damage to the charging cable.

In one example, the charging system 302 includes a charging station 310 and the charging cable 300 having a theft deterrent system. The charging station 310 works with the charging cable 300 to aid in alarming, notifying, and deterring a cable theft event. In one example, the cable 300 theft deterrent system includes a theft deterrent compound associated with the cable 300. In another example, the theft deterrent system includes a cable alarm system (e.g., for example, a cable break alarm, a cable movement alarm, or a cable proximity alarm). In another example, the theft deterrent system includes a charging cable tracking device.

In operation, the charging cable 300 is operably coupled to charging station 310 and operably coupled to an electric vehicle 316. The charging station 310 includes a controller 318 in communication with an alarm system 320. The controller 318 controls operation of the charging station, including charging of the electric vehicle 316. In one example, the alarm system 320 includes an audio alarm, visual alarm, a digital alarm, or more than one of an audio, visual, or digital alarm. The audio alarm can include an audio alarm device (e.g., a loudspeaker) local to the charging station 310. The visual alarm can include one or more visual alarm lights located local to the charging station 310. The digital alarm can include a digital alarm local to the charging station 310, and can also provide a digital alarm alert to the electric vehicle 316 master control unit 322, a charging station user, or a user interface 324 (e.g., a graphical user interface, phone, table, computer or other user interface that communicates with the charging station).

FIG. 16 is a diagram illustrating one example of charging cable with theft deterrent system 300. Charging cable 300 includes a charging plug at each end for operably coupling a charging station to an electric vehicle. Charging cable 300 includes a cable body 330 having a first end 332 and a second end 334. A charging station charging plug 336 is located at first end 332, and a charging plug 338 is located at second end 334. The cable body 330 extends between the first charging plug 336 and the charging plug 338.

Charging plug 336 plugs into a charging device, such as charging station 310. Charging plug 338 plugs into a charging port of an electric vehicle (e.g., electric vehicle 316 illustrated). In one example, charging plug 336 is a quick coupling device for electrical quick coupling to charging station port 340. Charging plug 336 can include a locking device 336a for locking the charging plug 336 to the charging station. Charging plug 338 is configured to plug into an electric vehicle charging port (e.g., electric vehicle 316 charging port 342. Similar to charging plug 336, charging plug 338 can include a locking mechanism 338a for locking the charging plug 338 to an electric vehicle (e.g., charging port 342 of electric vehicle 316) during charging of the electric vehicle.

Components of the theft deterrent system 300 can be located near the charging cable first end 332, the charging cable second end 334, or a location along the charging cable body 330.

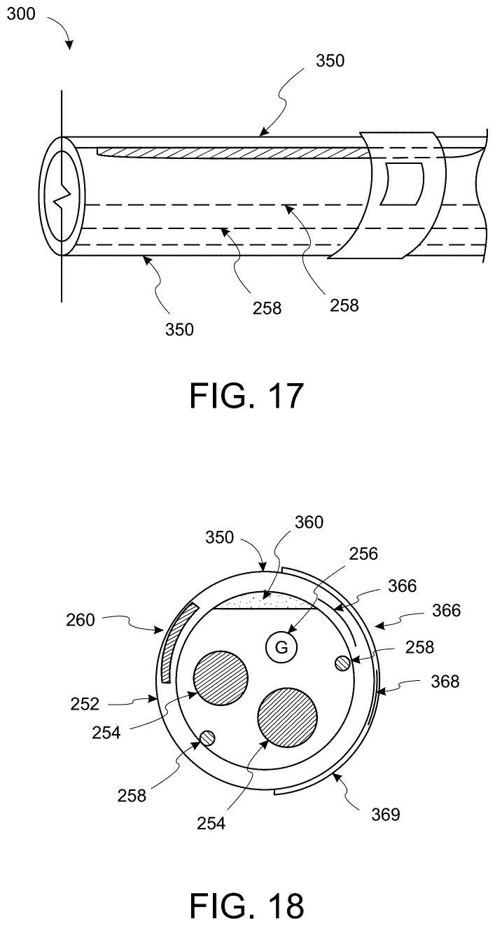

FIG. 17 and FIG. 18 are diagrams illustrating a charging cable having a theft deterrent system 300 for use with a charging system, according to examples of the present disclosure. Charging cable 300 is one example of charging cable 116 previously detailed herein. Charging cable 300 is configured as a cable suitable for charging an electric vehicle and further includes one or more cable alarm components. The cable alarm components are used as part of a cable alarm system to notify a user that the cable needs repair, has been damaged, or cut. The cable alarm components work in connection with the hidden charging unit (e.g., the smart CIU previously described herein) and/or the vehicle charging station 310 to provide local or remote audio, visual, and/or digital alarm notifications.

In one example, the charging cable 300 is an insulated cable 350 that includes an outer jacket 252 (e.g., an insulated jacket), charging conductors 254 and a ground 256. In one example, alarm/control conductors 258 are located in the outer jacket 252 or inside the insulated jacket 252 with the charging conductors 254. Once connected to a charging station, a small control current is maintained periodically present in the alarm conductors 258. If damage occurs in the charging cable resulting in the alarm conductors 258 being damaged or cut, the control current in the alarm conductors 258 is cut off or minimized. The ev charging station 310 senses that the wires have been cut or damaged and goes into an alarm state. Based on a desired alarm protocol, visual or audio alarms 320 can be activated along with digital alarm notifications sent to a user interface (e.g., user interface 324).

In one example, the charging cable 300 includes an alarm or control foil 260 located in the cable outer jacket 252 or inside the outer jacket 252. The foil 260 is capable of carrying a control current, and is operable as part of a cable alarm system similar to the alarm/control conductors 258 previously detailed herein.

In one example, the charging cable 300 theft deterrent system includes a theft deterrent compound 360. The theft deterrent compound 360 can be located outside of the insulated cable jacket, inside of the cable, or within cable insulation layers. The theft deterrent compound 360 can be located inside a sealed layer, inside a capsule layer, or contained within a skin or membrane. The theft deterrent layer can be located within the charging cable 300 under pressure. Once the charging cable is cut or damaged, the theft deterrent compound is released. When under pressure, the theft deterrent compound sprays out when released.

In one example, the theft deterrent compound 360 is a marking compound. Once the charging cable 300 is cut or damaged, the marking compound is released. The marking compound can be similar to a paint, chalk, or other type of marking compound. In another example, the theft deterrent compound 360 is a smell or stink compound. When released or sprayed out, a distinct smell, odor or foul smelling compound is released. In another example, the theft deterrent compound 360 is a chemical compound that can be a harmful deterrent to the person stealing the cable. In one example, the chemical compound is similar to bear spray.

In another example, the charging cable having a theft deterrent system 300 includes a tracking system 366. The tracking system 366 includes a trackable device or tag 368 (e.g., a gps tracking tag or air tag). The trackable device or tag 368 is located within the charging cable, within the charging cable insulation layer, or on the outside of the charging cable. When positioned on the outside of the charging cable 300, the tracking system 366 can be adhered to the charging cable 300 using an adhesive. In one example, the tracking system 366 is comprised as a traceable device 368 contained within a sticker 369 that can be adhered to the charging cable 300.

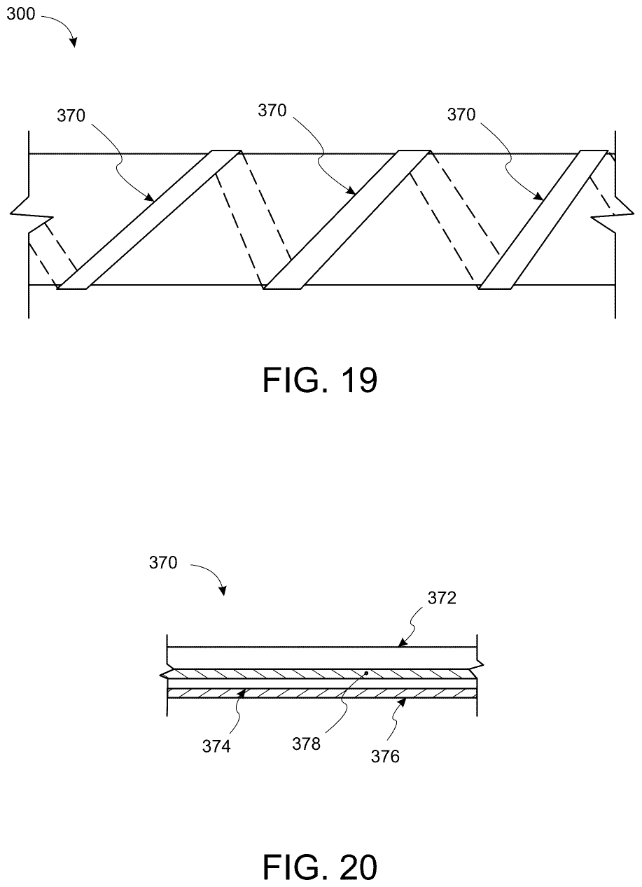

FIG. 19 illustrates one example of a charging cable including a theft deterrent compound 300. The charging cable 300 includes a theft deterrent compound in the form of a tape 370 wrapped around the charging cable in a helical manner or design.

FIG. 20 illustrates one example of theft deterrent tape 370. Theft deterrent tape 370 includes a first outer layer 372 and a second inner layer 374 having adhesive 376 thereon. A theft deterrent compound 378 is located between the first outer layer 372 and the second inner layer 374. The theft deterrent compound can be any suitable theft deterrent compound, including those previously disclosed herein (e.g., a marking compound, stink compound chemical compound or other). The theft deterrent compound may or may not be under pressure.

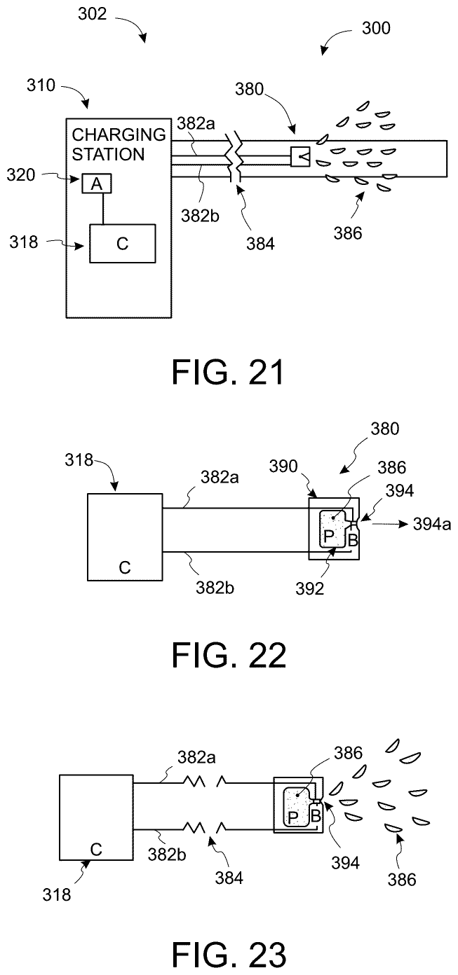

FIG. 21 illustrates one example of a charging cable having a theft deterrent compound 300. The charging cable 300 includes a controlled spray device 380. The controlled spray device 380 is an actuatable spray device. In one example, the spray device 380 is coupled to charging station 310 via one or more alarm wires 382a, 382b. If the charging cable 300 is broken, damaged or cut, as indicated at 384, the circuit between spray device 380 and charging station 310 is broken. This results in spray device 380 releasing a theft deterrent compound (e.g., stink spray, bear spray, color marker, etc.) contained therein, indicated at 386.

FIG. 22 illustrates one example of spray device 380. The spray device 380 is a micro-spray device. In one example, the spray device 380 dimensions are 10 mm long by 5 mm wide by 2 mm thick. In one example, the spray device 380 includes a housing 390, a compound chamber 392, and a valve 394. Theft deterrent compound 386 is contained in the compound chamber 392. In one example, the theft deterrent compound 386 is under positive pressure P within the compound chamber 392. Valve 394 is coupled to charging station 310 controller 318 via control alarm wires 382a, 382b. During normal operation, valve 394 maintains theft deterrent compound 386 within chamber 392. In one example, valve 394 is a one-way valve, indicated by arrow 394a. In one or more examples, valve 394 is a magnetic valve.

FIG. 23 illustrates one example of spray device 380 when in an alarm condition. Cable 300 has been cut, damaged, or broken, resulting in at least one of control alarm wires 382a, 382b being broken as illustrated at 384. The alarm condition and a broken control wire results in the opening (i.e., actuation) of valve 394. Theft deterrent compound 386 is released (i.e., sprayed) from spray device 380 under pressure through valve 394.

In one example, spray device 380 is a timed release spray device. The spray device 380 valve 394 does not immediately open to release the theft deterrent compound 386. The theft release compound is released at a later time when the charging cable has been removed and is away from the charging station 310 and possibly a vehicle that has received a charge. In one example, the spray device 380 includes a small battery B for timed release of the theft deterrent compound 386. In one example, the spray device 380 includes a microcontroller to control the actuation of valve 394 and timed release of the theft deterrent compound 386.

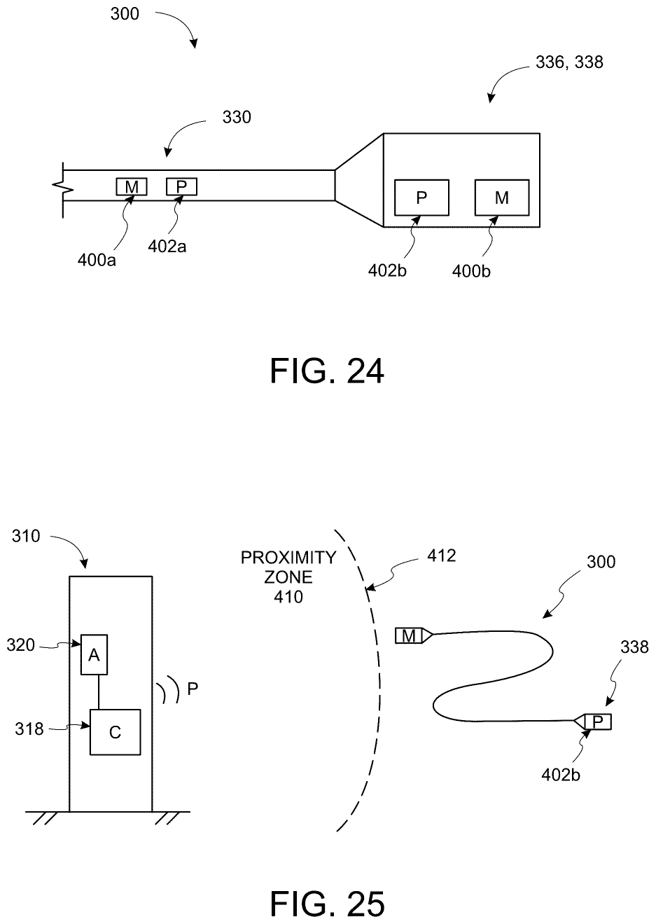

FIG. 24 illustrates one example charging cable having a theft deterrent system 300. The charging cable 300 includes a motion detector. When motion is detected during a charging operation or when the charging cable is in a still mode, the charging cable alarms via charging station controller 318. The motion detector can be located at any desired location along the length of the charging cable. In one example, a motion detector 400a is located along the cable body 330. In another example, a motion detector 400b is located within a charging plug such as charging plug 336 or charging plug 338. In one example, the motion detector is an accelerometer. The motion detector can communication via wired or a wireless communication link with charging station 310 controller 318.

Charging cable having a theft deterrent system 300 can also include a proximity sensor. The proximity sensor can be located at any desired location along the length of the charging cable. In one example, a proximity sensor 402a is located along the charging cable body 330. In one example a proximity sensor 402b is located in charging plug 336 or charging plug 338.

FIG. 25 is a diagram illustrating one example operation of charging cable 300 having a proximity sensor. A proximity zone is defined within a predetermined distance from charging station 310. If charging cable 300 is stolen, taken, or moved outside outside of proximity zone 410 a proximity alarm condition exists. In one example, the proximity zone 410 includes a proximity boundary 412. The charging station 310 no longer detects changing cable 300 outside of proximity boundary 412. As such, if charging cable 300 including proximity sensor 402b is moved outside of proximity boundary 412 the charging station 310 can no longer detect the presence of charging cable 300. With charging cable 300 located beyond proximity boundary 412 an alarm condition exists, and the charging cable owner is notified. Additionally, this can result in one or more audio, visual or digital alarms from the charging station 310 including alarm system 320.

It is recognized that the charging system disclosed can be configured for use in many charging system applications, including those not disclosed herein.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein.

The claims are part of the specification.

1. An electric vehicle charging system comprising:
an electric vehicle charging station; and
a charging cable with an anti theft system in communication with the charging station.

2. An electric vehicle charging system including an anti theft cable as disclosed herein and equivalents.
